(19) United States
(12) Patent Application Publication
(10) Pub. No.: US 2010/0064921 A1
(43) Pub. Date: Mar. 18, 2010

(54) LIMITING PLATE SHIFTING WITHIN A PLATE PALLET

(76) Inventors: Pavel Korolik, Petah-Tikwa (IL); Mark Silverman, Tel-Aviv (IL); Shay Regev, Rishpon (IL)

Correspondence Address: Amelia A. Buharin;Patent Legal Staff, Eastman Kodak Company, 343 State Street, Rochester, NY, 14650-2201, US

(21) Appl. No.: 12/212,867

(22) Filed: Sep. 18, 2008

(51) Int. Cl. B41F 1/28; B65G 57/24

(52) U.S. Cl. 101/474; 101/483; 414/791.6

(57) ABSTRACT

An apparatus for limiting the movement of plates within a plate stack (11) where the plate stack (11) is positioned on a plate pallet (13) during plate handling in a computer-to-plate (CTP) imaging device. The apparatus includes a plate pallet adapter (17) configured to carry the plate stack (11) which is positioned on the plate pallet (13), and the plate pallet (13) is positioned on the plate pallet adapter (17). At least one limiter (19, 51) is attached to at least one facet of the plate stack wherein the limiters are configured to limit movement of the plate stack (11).

### CROSS REFERENCE TO RELATED APPLICATIONS

Reference is made to commonly-assigned copending U.S. patent application Ser. No. 12/045,058, filed Mar. 10, 2008, entitled PLATE PALLET ALLIGNMENT SYSTEM, by Korolik et al., the disclosure of which is incorporated herein.

### FIELD OF THE INVENTION

The present invention relates to an apparatus and methods to properly align originally packed printing plate pallets into a computer-to-plate imaging device.

### BACKGROUND OF THE INVENTION

A variety of systems and applications use stacks of sheets or plates or both, which may be made of metal, paper, plastic, and the like. Printing plates (hereinafter singly or collectively referred to as “plates”) are typically stacked in plate pallets which house the plates and facilitates their protection, transportation, and handling.

A system for handling printing plates will generally use cassettes having specific dimensions. Cassettes can usually be set to contain plates of various sizes, but all plates in the same tray are of one size. The plates may be manually removed from the plate pallets and inserted into the cassettes for use by the plate imaging system. Plates packed in plate pallets are separated by intermediate paper sheets, hereinafter referred to as separation paper.

Cassettes containing printing plates are heavy and bulky, and moving such trays requires complicated and expensive mechanisms and is time consuming; specifically, during the loading of the plates from the plate pallets into the cassettes. There is a widely recognized need for an automatic and efficient handling system for feeding plates directly from the original plate pallet into the imaging device, while maintaining precise alignment of the plate during the plate feeding process. This need is addressed by the invention described in commonly-assigned U.S. patent application Ser. No. 12/045,058.

The plate stacks received from plate manufacturers often comprised of at least 600 plates. Each plate is separated from the next by a separation paper, and the entire stack of plates is placed on a pallet. Plates may shift or fall from their original position, during transportation of the pallet into the plate loading device or during the loading process of plates into the imaging unit. The shift can occur also during shipping of the plate stacks from the manufacturer to the end user.

The invention disclosed hereunder suggests a solution to the described problem.

### SUMMARY OF THE INVENTION

Briefly, according to one aspect of the present invention an apparatus limits the movement of plates within a plate stack where the plate stack is positioned on a plate pallet during plate handling in a computer-to-plate (CTP) imaging device. The apparatus includes a plate pallet adapter configured to carry the plates stack, which is positioned on a plate pallet, and the plate pallet is positioned on a plate pallet adapter. At least one limiter is attached to at least one facet of the plate stack wherein the limiters are configured to limit movement of the plate stacks.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic perspective view of a plate pallet with limiters;

FIG. 2 is a schematic top view of a plate pallet with limiters;

FIG. 3 is a schematic cross-sectional view of a plate pallet with limiters;

FIG. 4 is a schematic perspective view of an automatic plate loader (APL) with plates stack inserted into the APL;

FIG. 5 is a schematic perspective view of a plate pallet with different type of limiters positioned on different sides of the stack;

FIG. 6A is a schematic perspective view of a limiter in an open position;

FIG. 6B is a schematic perspective view of a limiter in a closed position (collapsing part positioned on the fixed part);

FIG. 7A is a schematic cross-sectional view of a limiter in an open position; and

FIG. 7B is a schematic cross-sectional view of a limiter in a closed position (collapsing part positioned on the fixed part).

### DETAILED DESCRIPTION OF THE INVENTION

The present invention describes apparatus and methods to receive a pallet of printing plates in an original manufactured form into a computer-to-plate (CTP) imaging device. The plate pallet is brought into the CTP device, using regular fork lift machinery. This process introduces inherent position inaccuracies in placing the pallet, in respect to the plate loading system. The plate loading system, on the other hand, requires high precision prerequisites. The invention disclosed hereunder bridges between these two realms. The plate pallet is consumed by an automatic pallet loading (APL) device attached to the CTP device. APL receives the bulk of plates originally packed on a pallet. The stack of plates 11 on the pallet which are brought into the APL, should be positioned and aligned precisely relative to the plate loading system, in order to allow proper plate loading functionality, directly from the pallet.

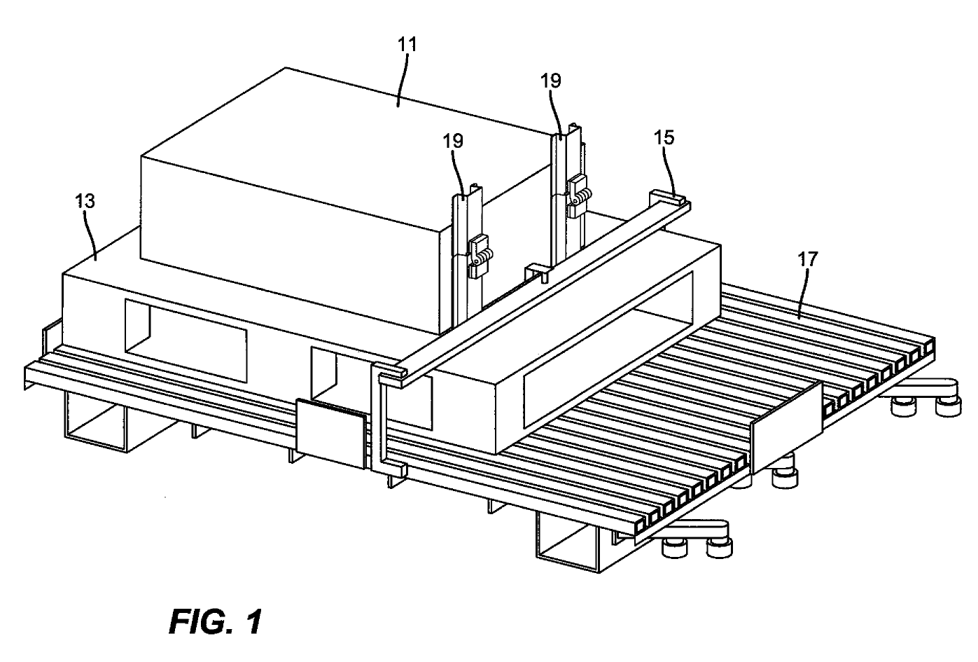

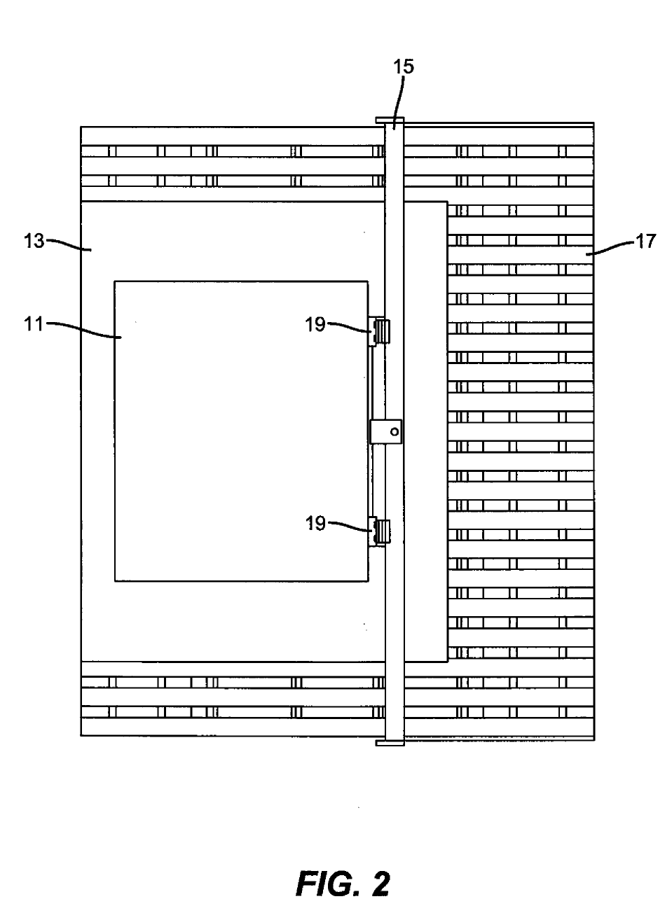

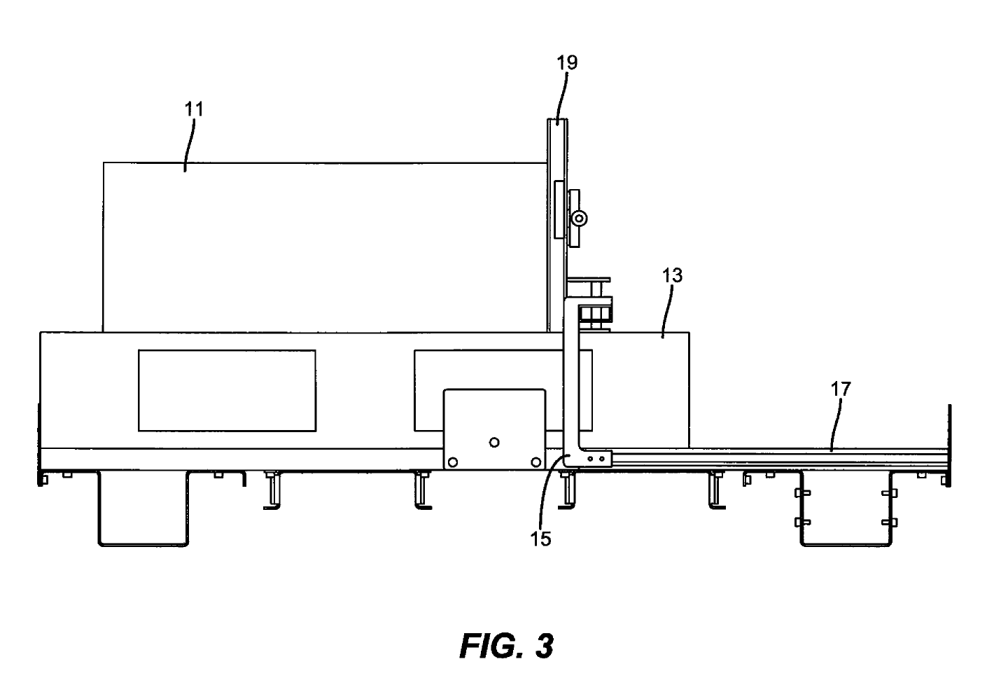

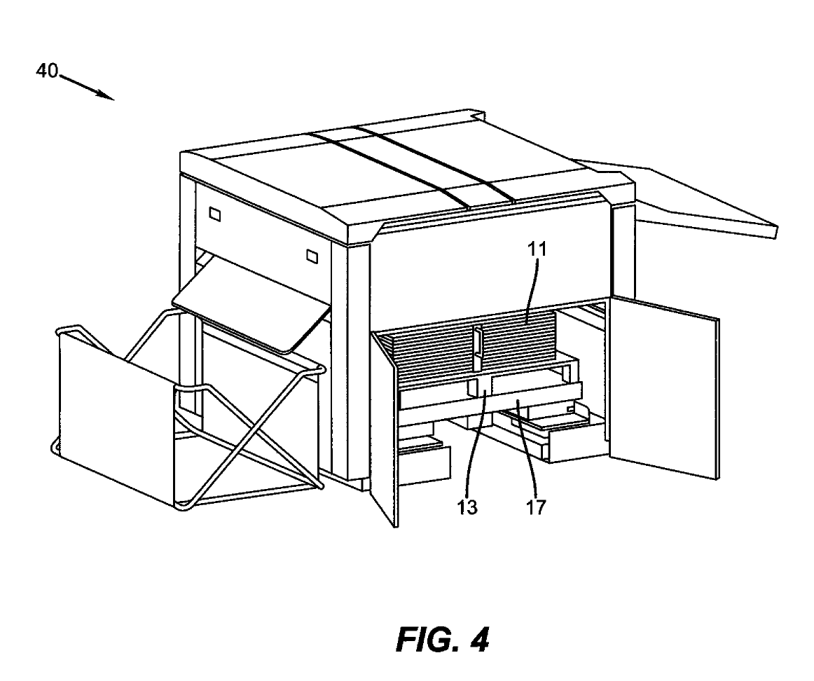

FIGS. 1, 2, and 3 show plate stacks 11 are placed on a plate pallet 13. The plate stacks 11 and plate pallet 13 are in a form as originally delivered from the plate manufacturers. The plate stacks 11 and plate pallet 13 are positioned on a plate pallet adapter 17 at the printing site in order to be inserted into an APL device 40 as is illustrated in FIG. 4.

In order to secure plate stacks 11 and avoid any shift of plates or separation sheets in the stack during the various transportation stages of plate stack 11 or during the loading process of plates into the image unit, plate limiter 19 is introduced. A limiter 19 is installed on at least one facet of the plate stack 11. Limiter 19 is secured to plate pallet adapter 17 via a limiter support frame 15 and fastens plate stacks 11 from shifting by pressing on a facet of plate pallet 13 with at least one plate stack limiter 19.

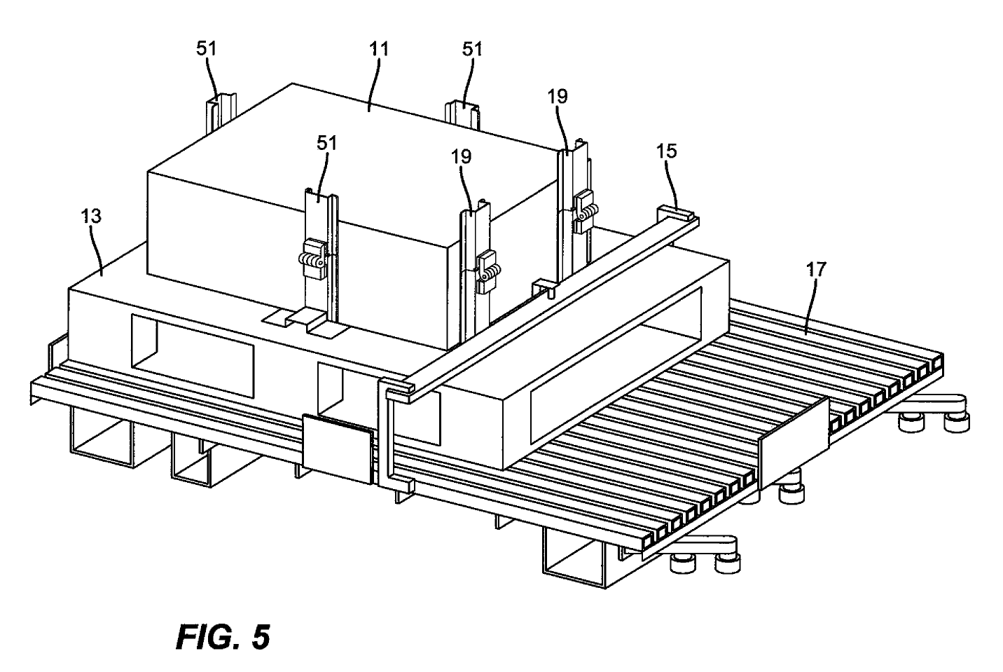

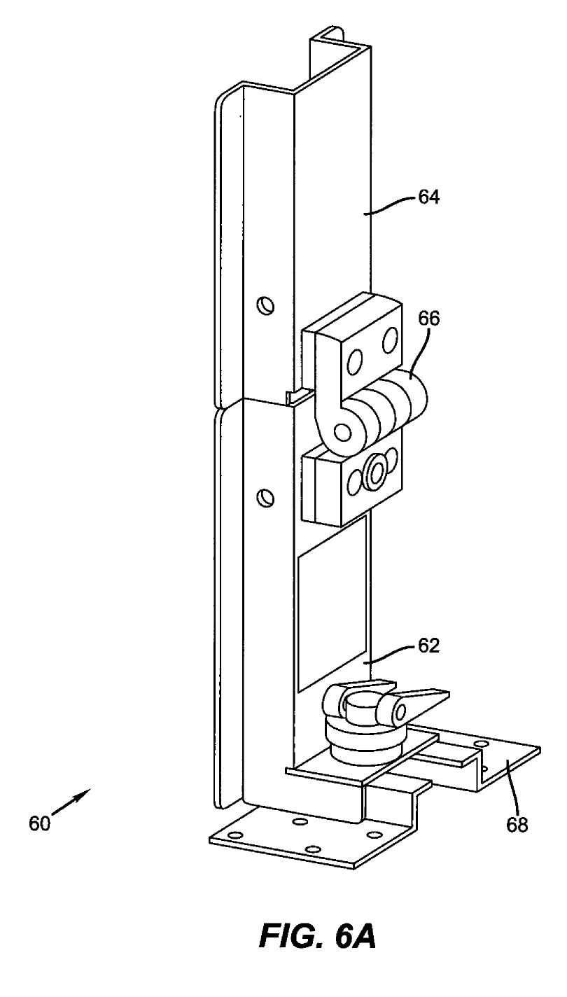

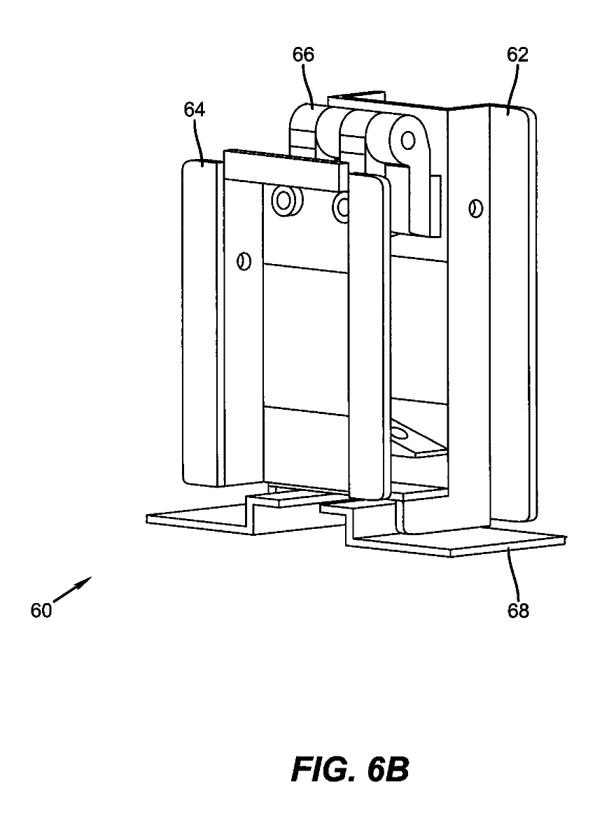

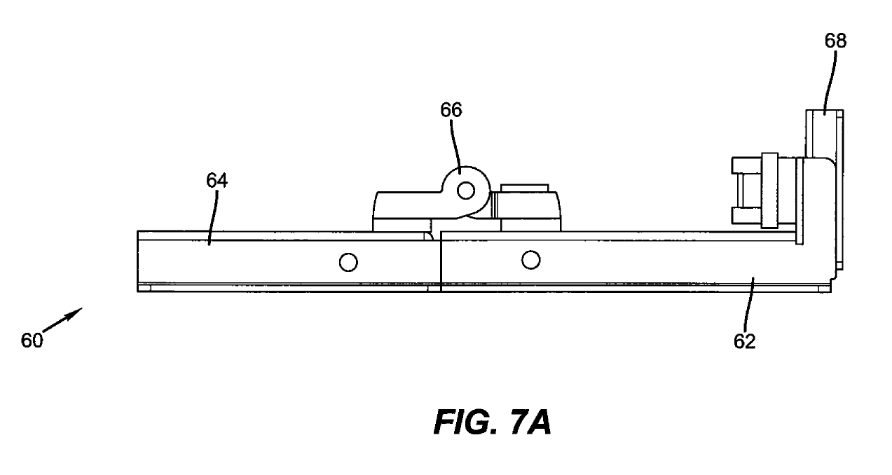

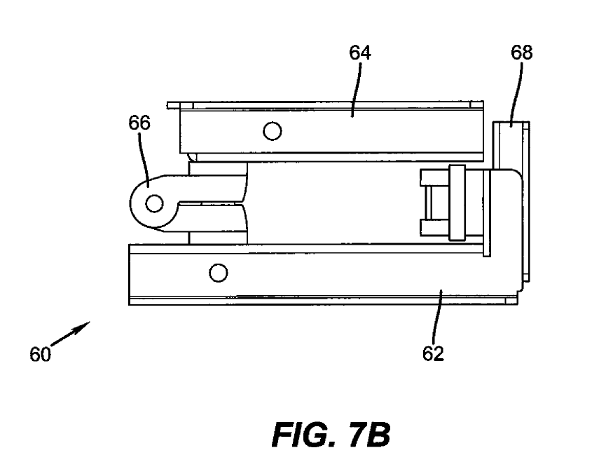

Another type of a limiter is introduced in FIG. 5. Limiter 51 is secured to plate pallet 13 and fastens plate stacks 11 from shifting. Limiter 51 can be installed at the plate manufacturer site or at the imaging unit site. FIG. 5 also shows limiter 19 supported by a limiter support frame 15, wherein limiter 19 fastens plate stack 11 on one facet and limiters 51 are attached to plate pallet 13 and are fastening plate stack 11 at all the remaining facets. Limiter 19 and limiter 51 are constructed from at least two parts. FIGS. 6A, 6B, 7A, and 7B show an exemplary configuration of such a limiter structure 60. The limiter comprised from limiter bracket 68 or limiter base. The limiter bracket is used to secure the limiter to plate pallet adapter 17 or plate pallet 13. The limiter structure 60 contains two fastening parts. The first part is a fixed limiter segment 62 attached from one end to limiter bracket 68 and is connected from the other end via a hinge 66 to a collapsing limiter segment 64.

In the stage where plate stacks 11 contain a large amount of plates and the stack needs a high limiter support, the limiter 19 or 51 will be in an open position. In an open position, as is shown in FIGS. 6A and 7A, the collapsing limiter segment 64 will stand on top of the fixed limiter segment 62, both segments 62 and 64 fasten the entire height of plate stacks 11.

In the stage where plate stacks 11 contains less than a certain quantity of plates, the limiter 19 or 51 will be in a closed position. In a closed position, as is shown in FIGS. 6B and 7B, the collapsing limiter segment 64 will collapse on the fixed limiter segment 62, fastening just with the fixed limiter segment 62.

The invention has been described in detail with particular reference to certain preferred embodiments thereof, but it will be understood that variations and modifications can be effected within the scope of the invention.

### PARTS LIST

11 plate stacks
13 plate pallet
15 limiter support frame
17 plate pallet adapter
19 limiter
40 automatic plate loader (APL) device
51 limiter
60 limiter structure
62 fixed limiter segment
64 collapsing limiter segment
66 hinge
68 limiter bracket (base)

1. An apparatus for limiting movement of plates in a plate stack wherein said plate stack is positioned on a plate pallet during plate handling in a computer to plate (CTP) imaging device comprising:
plate pallet adapter configured to carry said plate stack positioned on said plate pallet wherein said plate pallet is positioned on said plate pallet adapter; and
at least one limiter is attached to at least one facet of said plate stack wherein said at least one limiter is configured to limit movement of said plate stack.

2. The apparatus according to claim 1 wherein said limiter is attached to said pallet adapter.

3. The apparatus according to claim 1 wherein said limiter is attached to said plate pallet.

4. The apparatus according to claim 1 wherein said at least one limiter is positioned horizontally in respect to said plate pallet adapter.

5. The apparatus according to claim 1 wherein more than one limiter is attached to said plate pallet adapter and each of said more than one limiter is configured to limit movement of at least one facet of said plate stack.

6. The apparatus according to claim 1 wherein said at least one limiter further comprises a height adjustment element.

7. The apparatus according to claim 1 wherein said at least one limiter further comprises more than one limiter segment wherein each two consecutive said limiter segments are connected by a connecting element.

8. The apparatus according to claim 7 wherein said limiter is configured to operate in an open position or in a closed position.

9. The apparatus according to claim 7 wherein said limiter element is in an open position and said two consecutive segments are one on top of the other.

10. The apparatus according to claim 7 wherein said limiter element is in a closed position said two consecutive segments are parallel to each other.

11. The apparatus according to claim 7 wherein said limiter element is stabilized with a spring.

12. The apparatus according to claim 7 wherein said limiter element is stabilized with a magnet.

13. The apparatus according to claim 7 wherein said connecting element is a hinge.

14. The apparatus according to claim 7 wherein said connecting element is integrated in each of said limiter segments.

15. A method for limiting movement of plates in a plate stack wherein said plate stack is positioned on a plate pallet during plate handling in a computer-to-plate (CTP) imaging device comprising the steps of:
providing a plate pallet adapter configured to carry said plate stack wherein said plate stack is positioned on said plate pallet and wherein said plate pallet is positioned on said plate pallet adapter; and
attaching at least one limiter to at least one facet of said plate stack wherein said at least one limiter is configured to limit movement of said plate stack.

16. The method according to claim 15 wherein said limiter is attached to said pallet adapter.

17. The method according to claim 15 wherein said limiter is attached to said plate pallet.
